(19) United States
(12) Patent Application Publication
(10) Pub. No.: US 2007/0098227 A1
(43) Pub. Date: May 3, 2007

(54) Biosensor

(75) Inventor: Mitsuasa Takahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD.

(21) Appl. No.: 11/586,578

(22) Filed: Oct. 26, 2006

(30) Foreign Application Priority Data
Oct. 27, 2005 (JP) 2005-313568

(51) Int. Cl. G06K 9/00

(52) U.S. Cl. 382/115

(57) ABSTRACT

An optical biosensor that is capable of reading a fingerprint or a vein pattern with high efficiency of light reception. A louver is provided between a backlight unit and a substrate in a sensor for identifying a fingerprint by a process in which light emitted from the backlight unit passes through the substrate and is radiated to a fingerprint that is in contact with the upper surface of a protective layer, and light that is reflected according to the surface irregularity of the fingerprint is received by a semiconductor layer that is a light-receiving element. The emitted light is thereby provided with sharp directivity, and the efficiency of light reception by the sensor is therefore increased.

### BACKGROUND OF THE INVENTION

1. Field of the Invention

The present invention relates to an optical biosensor that is capable of reading a fingerprint or a vein pattern.

2. Description of the Related Art

Biological authentication through identification of fingerprints or vein patterns has recently come into use for ensuring the security of mobile telephones, personal computers, and other devices. A fingerprint sensor may operate optically, or according to capacitance (see Japanese Laid-open Patent Application No. 2002-267408, for example), pressure, or another property, and optical sensors and capacitance sensors are advantageous in terms of precise fingerprint detection. However, a capacitance fingerprint sensor has the drawback of being susceptible to electrostatic discharge, and since the sensor substrate of an optical fingerprint sensor is a semiconductor, a large sensor is extremely expensive. Furthermore, vein sensors have also been limited in the past to CCD (Charge Coupled Device) sensors, CMOS (Complementary Metal-Oxide Semiconductor) sensors, and other optical vein sensors. In order for biosensors to become so pervasive as to substitute for a door key, for example, durability and precision must be provided so that a fingerprint can be detected consistently when a finger is fixed on the sensor, and low cost is also desired.

Optical sensors obtained by increasing the light transmittance of a fingerprint-reading photosensor unit have been developed. Specifically, a backlight is provided to the back surface of the photosensor unit, light is emitted from this backlight to the photosensor unit, and the light that passes through the photosensor unit reflects off the end of a finger that touches the surface of the photosensor unit. The reflected light is detected by the photosensor to identify the fingerprint. Photosensors of this type include photosensors that emit light from the direction of the line normal to the surface of a fingertip and read the light that is reflected off the convex portion of the fingerprint, photosensors that emit light at the critical angle of total reflectance using a prism and read the light that is reflected off the concave portion of the fingerprint, and other photosensors.

FIG. 1 is a perspective view showing the structure of the backlight in the conventional fingerprint sensor described in Japanese Laid-open Patent Application No. 2003-60844. FIG. 2 is a plan view showing the structure of the light-receiving substrate described in the same publication. As shown in FIG. 1, the backlight is provided with a light-guide plate 101, a light source 100 provided to the side of the light-guide plate 101, a prism 102 provided to the top portion of the light-guide plate 101, and a diffusing sheet 103 provided above the prism 102. The light emitted from the light source 100 enters the light-guide plate 101, and is emitted from the light-guide plate 101 to the prism 102 in accordance with a reflecting pattern provided to the bottom portion of the light-guide plate 101. The light that is incident on the prism 102 is endowed with directivity by the prism portion and emitted to the diffusing sheet 103. Light that is scattered by the diffusing sheet 103 passes through the light-receiving substrate, the light is radiated to a fingerprint that is in contact with the surface of the light-receiving substrate, and the fingerprint is read by the reception of the reflected light.

As shown in FIG. 2, the light-receiving substrate has a structure in which two normal inversely staggered TFTs (Thin Film Transistor) composed of a bottom gate 104, a drain 105, and a source 106 are connected in series, and also has a top gate 107 above the TFT as viewed from above. The drain 105 and the source 106 are connected to a drain line 108 and a source line 109, respectively. A fingerprint can be read by a process in which light that is incident on the light-receiving substrate from the backlight is emitted to the fingerprint from gaps in the wiring of the light-receiving substrate, the light reflects between the finger and the surface of the substrate, and the reflected light is measured as an electric charge according to the intensity of the light that enters the TFT.

The observation of blood flow in a palm by receiving light that is transmitted through an organic body (palm of a hand) is described in section 3.1 “Optical Fluoroscopy and Imaging of In Vivo Functions” (pp. 80-105) of Bio-information Visualization Techniques Editorial Committee ed., “Bio-information Visualization Techniques,” Corona Publishing Co., 1997.

However, the conventional technique described above has such drawbacks as the following. As shown in FIG. 1, the conventional fingerprint sensor described in Japanese Laid-open Patent Application No. 2003-60844 uses a prism 102 to impart directivity to the light from the backlight, and sharp directivity is therefore unobtainable. The direction in which light is emitted must also be confirmed by tracing the light path, and it is also difficult to freely set the direction of emission. Furthermore, a pattern that is unrelated to the emission direction is also used in the layout of the light-receiving substrate, and the conventional technique has drawbacks in that light is received with low efficiency.

As described above, a capacitance fingerprint sensor also has the drawback of being susceptible to electrostatic discharge.

### SUMMARY OF THE INVENTION

An object of the present invention is to provide an optical biosensor that is capable of reading a fingerprint or vein pattern with high efficiency of light reception.

The biosensor according to the present invention comprises a light-receiving substrate in which a light-receiving element is formed on a translucent substrate, a protective layer for protecting the light-receiving element, a backlight for emitting light from a back surface of the substrate, and a louver for directing emitted light from the backlight. The louver is provided between the backlight and the substrate. A fingerprint or a vein pattern is detected by a process in which light that is endowed with directivity by the louver is radiated to an organic part placed on the protective layer, reflected light is received by the light-receiving element, and an intensity of the reflected light is detected.

In the present invention, light that is emitted from the backlight is provided with sharp directivity by being passed through the louver. The light that has passed through the louver is transmitted through the light-receiving substrate, radiated to an organic part that is placed on the protective layer, and then reflected, after which the light is detected by the light-receiving element. In a fingerprint sensor, for example, a fingerprint is read by a process in which reflected light is detected by the light-receiving element in accordance with the surface irregularity of a fingerprint, and the intensity of the reflected light is scanned in two dimensions. Since the illuminating light has directivity in this instance, the efficiency of light reception is increased, and a fingerprint can be detected with high precision.

The sensor may be configured such that an opaque film having an opening for transmitting light is formed on a surface of the substrate, and a direction that links the opening with the organic part on the protective layer is parallel to an emission direction of light that is directed by the louver. The efficiency of light reception is thereby significantly increased.

The light-receiving element may also comprise a lower electrode, a transparent upper electrode, and a semiconductor layer formed between the lower electrode and the upper electrode. By using a p-i-n light-receiving element as the semiconductor layer, for example, the arraying process of an LCD (Liquid Crystal Display) can be somewhat altered to manufacture the light-receiving substrate, and an inexpensive biosensor can be manufactured even when the surface area thereof is large.

The light emitted by the backlight may be near-infrared light having a wavelength of 600 to 700 nm or near 760 nm, for example. The biosensor is thereby made suitable for detecting a vein pattern. The reason for this is that large quantities of reduced hemoglobin flow in a vein, whereas large quantities of oxygenated hemoglobin flow in an artery, and since the absorption coefficient differs significantly between these two types of hemoglobin in the abovementioned wavelength band, light in this wavelength band is suitable for detecting a vein pattern.

The light emitted by the backlight may also have a wavelength of 400 to 760 nm. Light in this wavelength band is suitable for detecting a fingerprint.

Furthermore, the backlight may comprise two types of light sources that include a first light source for emitting near-infrared light at a wavelength of 600 to 700 nm or near 760 nm, and a second light source for emitting light that has a wavelength of 400 to 760 nm. Switching between the first and second light sources enables the biosensor to detect both a vein pattern and a fingerprint.

### BRIEF DESCRIPTION OF THE DRAWINGS

FIG. 1 is a perspective view showing the structure of the backlight in the conventional fingerprint sensor described in Japanese Laid-open Patent Application No. 2003-60844;

FIG. 2 is a plan view showing the structure of the light-receiving substrate described in Japanese Laid-open Patent Application No. 2003-60844;

FIG. 3 is a plan view showing the unit for detecting a fingerprint or a vein in the biosensor according to an embodiment of the present invention;

FIG. 4 is a longitudinal sectional view along line A-A shown in FIG. 3;

FIG. 5 shows the biosensor according to a modified example of an embodiment of the present invention, and is the same longitudinal sectional view as FIG. 4; and

FIG. 6 is a graph showing the wavelength dependence of the absorption coefficients of oxygenated hemoglobin and reduced hemoglobin as described in Bio-information Visualization Techniques Editorial Committee ed., “Bio-information Visualization Techniques,” Corona Publishing Co., 1997.

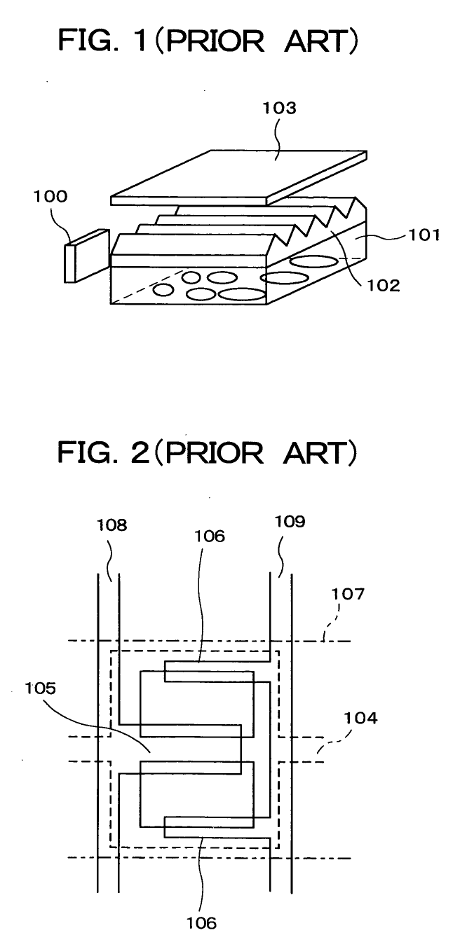

### DESCRIPTION OF THE PREFERRED EMBODIMENTS

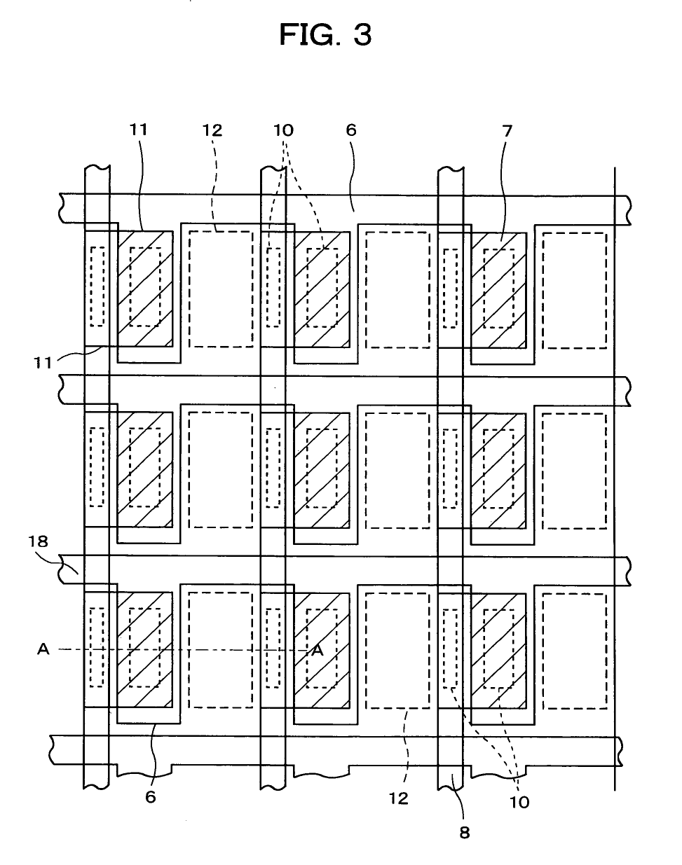

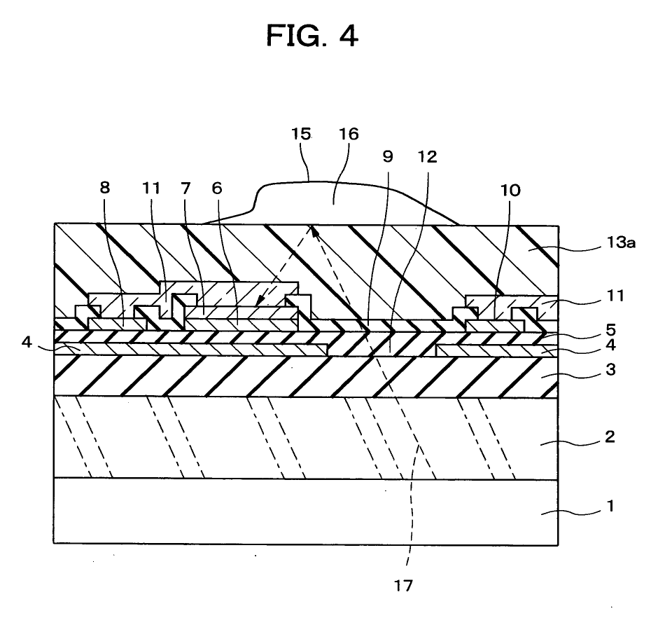

Embodiments of the present invention will be described in detail hereinafter with reference to the accompanying drawings. FIG. 3 is a plan view showing the unit for detecting a fingerprint or a vein in the biosensor according to the present embodiment, and FIG. 4 is a longitudinal sectional view along line A-A shown in FIG. 3.

As shown in FIG. 4, a louver 2 is placed on a backlight unit 1 that is composed of an LED (Light Emitting Diode), for example. The louver 2 is a louver film having a thickness of about 300 μm that is composed of a film in which transparent portions and opaque portions are layered in alternating fashion, for example. A light-receiving substrate is also placed on the louver 2. In the light-receiving substrate, a sensor element is formed on a transparent insulating substrate 3 composed of glass, for example. Specifically, an opaque film 4 having an opening 12 is formed on the substrate 3, a transparent insulating film 5 is formed on the opaque film 4 and in the opening 12, and a lower electrode 6 and data line 8 are formed in positions that are directly above the opaque film 4 on the insulating film 5. As shown in FIG. 3, the lower electrode 6 extends in the direction orthogonal to the data line 8, and is connected to a signal extraction line 18. A semiconductor layer 7 is formed on the lower electrode 6. The semiconductor layer 7 constitutes a light-receiving element with the lower electrode 6 and an ITO (Indium Tin Oxide) film 11 as an upper electrode described hereinafter. The semiconductor layer 7 is a diode that has a p-i-n joint in which p-i-n layers are layered in this sequence from bottom to top, for example. A transparent passivation film 9 is also formed on the entire surface of the substrate 3, and portions of the passivation film 9 localized above the semiconductor layer 7 and the data line 8 are removed to form contact holes 10. A transparent ITO film 11 is formed on the semiconductor layer 7 and the data line 8, the contact holes 10 of the semiconductor layer 7 and data line 8 are filled by this ITO film 11, and the data line 8 is electrically connected to the lower electrode 6 and the semiconductor layer 7. A protective layer 13a is also formed so as to cover the entire light-receiving substrate. The upper surface of the protective layer 13a is a fingerprint detection unit for detecting a fingerprint when touched by a finger. Each portion bounded by the signal extraction lines 18 and data lines 8 that form a lattice as shown in FIG. 3 is thus a sensor having an opening 12 and a semiconductor layer 7 (hatched region). In FIG. 4, an example is shown in which the organic part being detected is a concave portion of a fingerprint, and a gap 16 made up of an air layer is therefore formed between the fingerprint 15 and the upper surface of the protective layer 13a. The lower electrode 6 is used as a signal extraction line in the present embodiment, but the signal extraction line may be made to function as wiring that is separate from the lower electrode 6 by using an opaque film 4 or other wiring. Each constituent element will next be described in detail.

The protective layer 13a may be formed, for example, by forming a coating of an acrylic or other resin having a thickness of about 2 μm, and flattening the surface thereof. The emission angle of light that has passed through the substrate 3 and is reflected by the upper surface of the protective layer 13a depends on the material properties of the protective layer, but this emission angle is almost always ±30 degrees or less with respect to the line normal to the surface of the substrate 3.

As described above, a metal film (which can also be used as a signal extraction electrode), for example, is formed as the opaque film 4 on a glass, plastic, or other transparent, insulating substrate 3. This film is formed, for example, by using a sputtering method to form a Cr (chromium) film having a thickness of about 200 nm, and forming wiring by a common photoresist method, or by selectively forming a resist in portions where an opaque film remains, performing etching using a cerium nitrate-based etching solution, and peeling off the resist.

The insulating film 5 is formed by depositing a nitride film, for example, by a CVD (Chemical Vapor Deposition) method so as to have a thickness of about 300 nm, for example. The insulating film 5 may be layered so as to include an oxide film having a thickness of 100 nm, and a nitride film having a thickness of 200 nm.

The lower electrode 6 is formed by creating a film of Cr, for example, having a thickness of about 100 nm by a sputtering method, and performing a photoresist process, an etching process, and a peeling process. Besides Cr or another metal, the lower electrode 6 may be formed using ITO, SnO₂ (tin oxide), ZnO (zinc oxide), CuAlO₂ (copper aluminum oxide), SrCu₂O₂ (strontium copper oxide), or another oxide semiconductor or polymer semiconductor.

The semiconductor layer 7 may, for example, be formed according to the method described below. First, the entire surface of a substrate is plasma-treated in a gas (e.g., diborane (B₂H₆)) that contains boron (B). When an N-type semiconductor layer is formed on the lower electrode 6, the plasma treatment is performed in a gas (e.g., phosphine (PH₃)) that contains phosphorus (P). The plasma treatment is performed after the lower electrode 6 has been patterned, but may be performed subsequent to film formation and prior to the patterning treatment. The semiconductor layer 7 is formed by a process in which, for example, non-doped hydrogenated amorphous silicon having a thickness of about 200 nm is deposited by a CVD method; phosphorus-doped hydrogenated amorphous silicon, for example, is then deposited to a thickness of about 50 nm; and a common photolithography process and RIE (Reactive Ion Etching) process are performed. An example of hydrogenated amorphous silicon was described herein, but microcrystalline silicon, polycrystalline silicon, or the like may also be used in the same manner.

A data line 8 is then formed by sputtering, e.g., Cr into a film having a thickness of about 140 nm, performing a common photoresist process, and etching the Cr using a cerium nitrate-based etching solution.

A passivation film 9 is formed by depositing, e.g., a nitride film having a thickness of about 150 nm by a CVD method, and a contact hole 10 is formed by performing a common photolithography process and an etching process using a hydrofluoric acid-based etching solution. For the upper electrode of the semiconductor layer 7, an ITO film 11 having a thickness of about 50 nm is created by a sputtering method, for example, and the resist is removed by a common photolithography process and an etching process using an aqua regia-based etching solution.

The wavelength of light used to detect a fingerprint or a vein will next be described. Taking into account the wavelength band of light emitted by an LED as the light source, the wavelength band of light received by the semiconductor, and other factors related to a fingerprint sensor, a fingerprint can be detected using light that has a wavelength of 400 to 760 nm, for example. In a vein sensor, a pattern of veins can be detected using light that has a wavelength of 600 to 700 nm or near 760 nm, for example. The reasons for using these wavelengths are as follows. FIG. 6 is a graph showing the wavelength dependence of the absorption coefficients of oxygenated hemoglobin and reduced hemoglobin as described in Bio-information Visualization Techniques Editorial Committee ed., “Bio-information Visualization Techniques,” Corona Publishing Co., 1997. Since mostly reduced hemoglobin flows in veins, and mostly oxygenated hemoglobin flows in arteries, a wavelength (600 to 700 nm or near 760 nm, for example) where there is a large difference between the absorption coefficients of these two types of hemoglobin is suitable for detection of a vein pattern.

The operation of the biosensor according to the present embodiment thus configured will next be described. As shown in FIG. 4, a louver 2 for limiting the direction in which light is emitted is provided between the backlight unit 1 and the substrate 3. The light emitted from the backlight unit 1 is directed by the louver 2. to enter the light-receiving substrate from the opening 12 on the substrate 3. In this arrangement, light that is directed at an angle with respect to the direction of the louver 2 is blocked, and light that is in substantially the same direction as the louver 2 is emitted from the louver 2. The emitted light is again transmitted through the light-receiving substrate and reflected according to a vein pattern or the fingerprint 15 of a finger placed on the protective layer 13a . The reflected light is received by the semiconductor layer 7 (see the light path 17). In the example of fingerprint detection, since a gap 16 made up of an air layer is formed in the space between the concave portion of the fingerprint and the upper surface of the protective layer 13a , the light is almost totally reflected, and the reflected light becomes more intense. Since there is no gap formed by an air layer between the convex portion of the fingerprint and the upper surface of the protective layer 13a , the light is absorbed by the finger, and the reflected light is less intense. The reflected light received by the semiconductor layer 7 is detected as a voltage or current according to the intensity of the light using the lower electrode 6 and the data line 8. A vein pattern or two-dimensional fingerprint data can therefore be obtained by scanning the lower electrode 6 and the data line 8.

An angle is selected for the direction of the louver in the case of fingerprint detection so as to maximize the ratio (contrast) between the case in which an air-layer gap is formed by the concave portion of the fingerprint, and light is strongly reflected, and the case in which light is absorbed by the finger in the convex portion of the fingerprint and is weakly reflected. In the case of vein detection, the direction of the louver is set to an angle that maximizes the vein contrast. An angle that maximizes the contrast of both the veins and the fingerprint is selected when a fingerprint and veins are both detected. Although dependent on the wavelength of the light, there is little difference between both types of angles.

The effect of the present embodiment will next be described. In the biosensor according to the present embodiment, since the light emitted from the backlight unit 1 is provided with sharp directivity by the louver 2, the efficiency with which the reflected light is received increases, and high-precision detection of fingerprints and vein patterns becomes possible. Since the emission direction is also easily set, the light reception efficiency can be even further increased when the layout of the light-receiving substrate is created with consideration for the emission direction. For example, the light-receiving substrate can be disposed so that the direction that links the opening 12 with the finger placement location is parallel to the emission direction of light that is directed by the louver. A configuration may also be adopted in which there is a substantial match between the direction of the opening 12 on the substrate 3 based on the point of origin of the light, the direction of the semiconductor layer 7 that is the light-receiving element based on the point of origin of the light, and the direction of emitted light that is directed by the louver 2. This configuration significantly increases the efficiency of light reception. The structure of the sensor is also simplified in comparison to the conventional technique that uses a lens or other focusing optical system. According to the present embodiment thus configured, the relationship between the light path and each component on the light-receiving substrate is geometrically well-defined, and a biosensor having excellent light reception efficiency can be formed. By using a p-i-n light-receiving element as the semiconductor layer 7, an inexpensive large-area biosensor can be manufactured by slightly altering the arraying process of an LCD (Liquid Crystal Display). The present embodiment also does not suffer from the drawback of susceptibility to electrostatic discharge, such as in a capacitance-type sensor.

When data relating to a vein pattern are acquired, there is some overlap with information relating to the fingerprint, due to reflection in the interface in contact with the finger. However, the precision with which the vein pattern is detected can be enhanced by using differential data with respect to the fingerprint pattern (detected pattern or registered pattern). It is also possible to enhance the precision of vein pattern detection by applying such methods as wetting the finger in a liquid so that an air space does not form in the concave portion of the fingerprint.

The lower electrode 6 is used as a signal extraction line in the present embodiment, but using the opaque film 4 or another element of wiring enables the signal extraction line to be an element of wiring that is separate from the lower electrode 6 (the signal extraction line and the lower electrode are electrically connected).

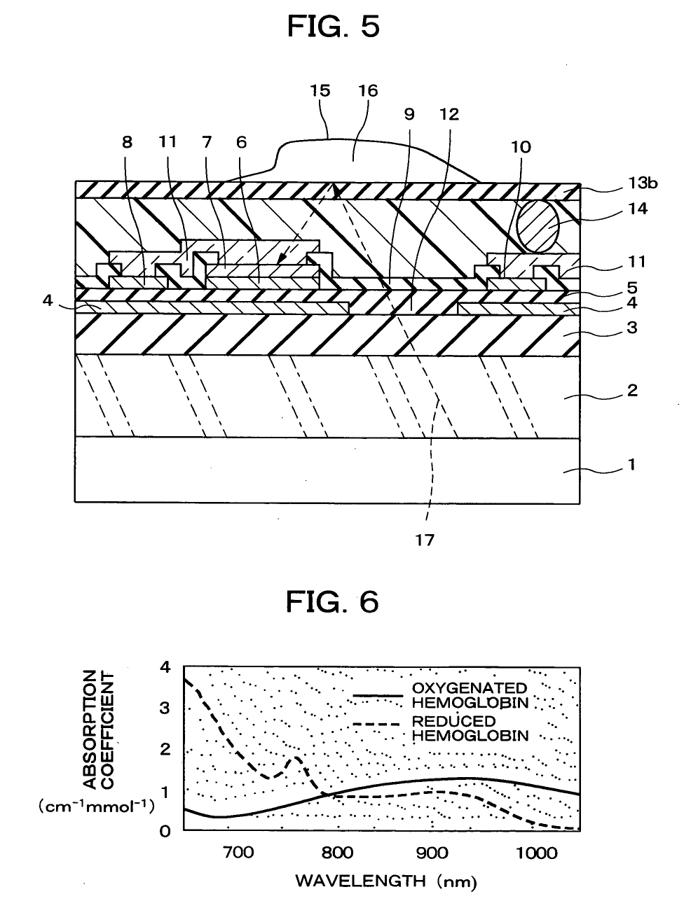

A modified example of an embodiment of the present invention will next be described. FIG. 5 shows the biosensor according to the present modified example, and is the same longitudinal sectional view as FIG. 4. As shown in FIG. 5, the present modified example differs from the aforementioned embodiment in that a spacer 14 is disposed between the substrate 3 and a protective film 13b that is formed on the surface of the light-receiving substrate. Specifically, the spacer 14 is held between the protective film 13b and an ITO film 11 that is formed on the substrate 3 in the example shown in the drawing. Other aspects of the present modified example are the same as in the previously described embodiment. The spacer 14 has a diameter of about 4 μm, for example, and may be spherical or cylindrical. A protective layer for covering the light-receiving element is formed by a process in which an ITO film 11 is formed, and a seal member having a width of about 2 mm is patterned on the periphery of the substrate 3, after which spacers 14 are distributed, and a glass, plastic, or other transparent substrate is bonded thereon. According to the present modified example, since rigid glass or the like is used to form the protective film 13b , the durability and moisture resistance of the unit for detecting a fingerprint or vein is enhanced in comparison to a case in which an acrylic resin is used to form the protective layer. The spacer 14 is used to maintain a gap between the protective film 13b and the semiconductor layer 7, and this gap is determined in conjunction with the angle of the direction of the louver.

Since a p-i joint does not appear on the etched surface when the semiconductor layer 7 in the present embodiment and modified example is patterned larger than the lower electrode 6, recombination centers are not formed near the joint, and an increase in leak currents can be suppressed. It is also possible to use the lower electrode, upper electrode, drain electrode, contact, and other components to connect a plurality of semiconductor layers 7 disposed in different positions on a plane, and to increase the electromotive force.

In the present embodiment and modified example, a layered diode is arranged in the sequence p-i-n from the bottom, but the opposite sequence n-i-p may also be used. The gate of a TFT may be connected to the lower electrode 6 (or a signal extraction line), the drain of the TFT may be connected to the data line 8, and a semiconductor layer 7 used for light reception may be connected between the source of the TFT and the lower electrode 6 to select a light-receiving element. Electrostatic shock can also be mitigated by forming an ITO film or other transparent electrode on the outermost surface of the sensor touched by the finger so as to create a ground connection via resistance, and the ITO film may also be used as an electrode of a touch sensor.

The present invention may be suitably used in mobile telephones, personal computers, door keys, and other devices that use bio-authentication.

What is claimed is:

1. A biosensor comprising:
a light-receiving substrate in which a light-receiving element is formed on a translucent substrate;
a protective layer for protecting said light-receiving element;
a backlight for emitting light from a back surface of said substrate; and
a louver for directing emitted light from said backlight, the louver being provided between said backlight and said substrate and radiating the light endowed with directivity to an organic part placed on said protective layer; wherein
said light-receiving element detects a fingerprint or a vein pattern by receiving a reflected light from the organic part and detecting an intensity of the reflected light.

2. The biosensor according to claim 1, further comprising:
an opaque film formed on a surface of said substrate, said opaque film having an opening for transmitting light; wherein
a direction that links said opening with said organic part on said protective layer is parallel to an emission direction of light that is directed by said louver.

3. The biosensor according to claim 1, wherein said light-receiving element comprises:
a lower electrode;
a transparent upper electrode; and
a semiconductor layer formed between the lower electrode and the upper electrode.

4. The biosensor according to claim 1, wherein
light emitted by said backlight is near-infrared light having a wavelength of 600 to 700 nm or near 760 nm; and
light in this wavelength band is used to detect a vein pattern of said organic part.

5. The biosensor according to claim 1, wherein
light emitted by said backlight has a wavelength of 400 to 760 nm; and
light in this wavelength band is used to detect a fingerprint of said organic part.

6. The biosensor according to claim 1, wherein
said backlight comprises two types of light sources that include a first light source for emitting near-infrared light at a wavelength of 600 to 700 nm or near 760 nm, and a second light source for emitting light that has a wavelength of 400 to 760 nm; and
said first and second light sources are switched to detect both a vein pattern and a fingerprint.
